(19) United States
(12) Patent Application Publication
(10) Pub. No.: US 2005/0104832 A1
(43) Pub. Date: May 19, 2005

(54) LCD panel driving device and circuit array using the same

(75) Inventors: Won Kee Lee, Anyang-Si (KR); Sung Hwi Park, Anyang-Si (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Displaychips Inc., Anyang-Si (KR)

(21) Appl. No.: 10/986,716

(22) Filed: Nov. 12, 2004

(30) Foreign Application Priority Data
Nov. 19, 2003 (KR) 10-2003-0082329

(51) Int. Cl. G09G 3/36

(52) U.S. Cl. 345/92

(57) ABSTRACT

The present invention relates to a driving integrated circuit IC for driving a liquid crystal display LCD and, more particularly, to an LCD panel driving device and a circuit array using the same, which simplifies the circuit array and reduces its manufacturing cost. The LCD panel driving device of the invention comprises output bumps 311 for outputting driving signals to the LCD panel and at least an input bump group 312 arranged in a perpendicular direction with the output bumps 311. The input bumps are coupled electrically with conductive patterns 32 formed on a base film 30 or a lower glass 1.

### BACKGROUND OF THE INVENTION

1. Field of the Invention

The present invention relates to a driving integrated circuit IC for driving a liquid crystal display LCD and, more particularly, to an LCD panel driving device and a circuit array using the same, which simplifies the circuit array and reduces its manufacturing cost.

2. Description of the Related Art

Recently, as various multimedia services are widely provided, diverse display devices for supplying pictures or moving picture have been developed and spread. A typical display device is that using a cathode ray tube CRT, which has a drawback that its size is big and its weight is heavy. Accordingly, display devices using a liquid crystal display LCD or a plasma display panel PDP have been popularized increasingly. Particularly, the LCD device has been widely used for its merit that it is very thick and light.

In general, the LCD device includes a liquid crystal panel formed by injecting a liquid crystal material between a lower glass having gate lines, data lines, thin film transistors, pixel electrodes, etc., for example, and an upper glass having black matrix, color pixels, common electrodes, etc. Here, the width and length of the lower glass are set larger than those of the upper glass, especially, the lower glass has a plurality of signal connecting members for connecting various driving signals, such as gate signal, source signals, clock signals and control signals applied from the outside, with a driving electric power source.

A configuration for supplying various driving signals to the liquid crystal panel is disclosed by Korean Patent Publication No. 2001-9044 titled: Signal connecting member for liquid crystal display and drive IC mount on the same. FIG. 1 is a layout showing a configuration disclosed in the above-mentioned Patent Publication. In the figure, reference numerals 1 and 2 denote a lower glass and an upper glass, respectively, that construct a liquid crystal panel. Numeral 3 denotes a printed circuit board PCB for supplying a driving electric power source, gate driving signals, data driving signals, etc., with the liquid crystal panel. On the PCB 3, there are established a DC-DC converter 301, a controller 302 and a plurality of driving devices for driving the liquid crystal panel.

The PCB 3 and the lower glass 1 are connected electrically and physically with each other through specific connecting members 4. On the connecting member 4 made of malleable film, a data driving device 401 for driving the liquid crystal panel is mounted in a flip-chip bonding manner and a plurality of conductive patterns are also formed, not depicted in the figure. The conductive patterns couple data applied form the PCB 3 with the data driving devices 401 and data driving signals output from the data driving devices 401 with data lines, not depicted, formed on the lower glass 1 electrically.

Meanwhile, gate driving signals applied from the PCB 3 are sent to the lower glass 1 through at least one connecting member among the plural connecting members 4 and coupled with base films 5 electrically through conductive patterns 11 for gate signals formed on the lower glass 1.

On the base film 5 made of a malleable material as same with the connecting member 4, a device for gate drive of the liquid crystal panel is mounted in the flip-chip manner and conductive patterns 52 are formed to connect the conductive patterns 11 on the lower glass 1 with the gate drive device 51 electrically.

Gate driving signals of the liquid crystal panel include electric power sources such as VDD (2.5˜5V), VSS (0V), VGH (+15˜+30V), etc., and signals such as CLK, DIO1, DIO2, OE, DIR, etc. Since the gate driving signals are used commonly by the respective gate drive devices 51, the gate drive device 51 re-outputs the gate driving signals input to a subsequent gate drive device 51.

FIG. 2 is a layout illustrating a configuration of the gate drive device 51 and the conductive patterns 52 established on the base film 5. The gate drive device 51 includes a plurality of output bumps 511, arranged in a row on one end, for outputting gate driving signals to the liquid crystal panel and a plurality of input bumps 512, formed in a row on the opposite end to the output bumps 511, for receiving gate driving signals. The input bumps 512 are divided into two groups 512a and 512b. The input bumps 512a of the first group are to receive the gate driving signals from the conductive patterns 52 on the base film 5 and the input bumps 512b of the second group are to output the gate driving signals input from the input bumps 512a through the conductive patterns 52 on the base film 5 to the subsequent base film 5. The input bumps 512a and 512b are coupled with each other electrically through predetermined metal lines 513.

However, the device having the above-described configuration has a following drawback: That is, in case of the conventional gate drive device 51, the input bumps 512a of the first group and the input bumps 512b of the second group are arranged in a row on one end of the device 51 and these input bumps 512 are positioned far from the liquid crystal panel. Accordingly, in forming the conductive patterns 52 on the base film 5 so as to connect the input bumps 512 with the conductive patterns 11 on the lower glass 1 electrically, the conductive patterns 52 are designed necessarily to go round the circumference of the device 51. In such a manner, if the conductive patterns 52 go round the device 51, further areas for accommodating the detour patterns are needed on the base film 50, which requires lots of expensive base films unnecessarily.

### BRIEF SUMMARY OF THE INVENTION

Accordingly, an object of the present invention is to provide a LCD panel driving device that can minimize the use of the base film by modifying the mounting structure of bumps on the LCD panel driving device.

Another object of the present invention is to provide a circuit array that can simplify the conductive patterns arranged on the base film or the lower glass using the LCD panel driving device.

To accomplish an object in accordance with a first aspect of the present invention, there is provided an LCD panel driving device that receives driving signals from an outside and outputs driving signals for driving the LCD panel, the LCD panel driving device comprising: first input bumps, established on one end of a gate drive device, for receiving driving signals from the outside; second input bumps, formed on the other end of the gate drive device, for outputting the driving signals to the outside; signal connecting members for coupling the first input bumps with the second input bumps electrically; and output bumps for outputting the driving signals to the LCD panel, the first and second input bumps being arranged in a perpendicular direction with the output bumps.

To accomplish another object in accordance with a second aspect of the present invention, there is provided an LCD panel driving device that receives driving signals from an outside and outputs driving signals for driving the LCD panel, the LCD panel driving device comprising: input bumps, established on one end of a gate drive device, for receiving driving signals from the outside; and output bumps for outputting the driving signals to the LCD panel, the input bumps being arranged in a perpendicular direction with the output bumps.

Besides, the LCD panel driving device of the present invention further comprises dummy bumps provided on an opposite end of the output bumps.

To accomplish an additional object in accordance with a first aspect of the present invention, there is provided a circuit array for driving an LCD panel that includes a printed circuit board PCB having a device for generating driving signals for driving the LCD panel and connecting members for connecting the PCB with a lower glass of the LCD panel electrically and physically to supply the driving signals with the LCD panel, the circuit array comprising: a plurality of base films, connected with the lower glass of the LCD panel, having the LCD panel driving device and first conductive patterns; and second conductive patterns, formed on the lower glass of the LCD panel, for coupling with the first conductive patterns electrically, the LCD panel driving device including output bumps for outputting the driving signals to the LCD panel and at least a row of input bumps arranged in a perpendicular direction with the output bumps.

To accomplish a further object in accordance with a first aspect of the present invention, there is provided a circuit array for driving an LCD panel that includes a printed circuit board PCB having a device for generating driving signals for driving the LCD panel and connecting members connecting the PCB with a lower glass of the LCD panel electrically and physically to supply the driving signals with the LCD panel, the circuit array comprising: conductive patterns that are formed on the lower glass and coupled with the driving signals input through the connecting members; output bumps, mounted on the conductive patterns, for outputting the driving signals to the LCD panel; and at least a row of input bumps arranged in a perpendicular direction with the output bumps.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a layout showing a configuration of a conventional device and circuit array for supplying driving signals to a liquid crystal panel;

FIG. 2 is a layout illustrating a configuration of a gate drive device 51 and conductive patterns 52 established on a base film 5 in FIG. 1;

FIG. 3 is a layout explaining a configuration of a gate drive device 31 and a circuit array in accordance with a preferred embodiment of the invention;

FIG. 4 is a layout showing how the concept of FIG. 3 is applied to the liquid crystal panel;

FIG. 5 is a layout illustrating a configuration of a gate drive device 51 and a circuit array in accordance with another embodiment of the invention;

FIG. 6 is a layout explaining how the gate drive devices 31 and the circuit array in FIG. 3 are embodied on a lower glass 1 in the liquid crystal panel.;

FIG. 7 is a layout depicted how the gate drive devices 51 and the circuit array in FIG. 5 are embodied on a lower glass 1 in the liquid crystal panel.;

FIG. 8 is a perspective view showing the exterior of the gate drive device 31 in FIG. 3; and

FIG. 9 is a perspective view illustrating the exterior of the gate drive device 31 in accordance with another embodiment of the present invention.

### DETAILED DESCRIPTION OF THE INVENTION

Reference will now be made in detail to the preferred embodiments of the present invention, examples of which are illustrated in the accompanying drawings.

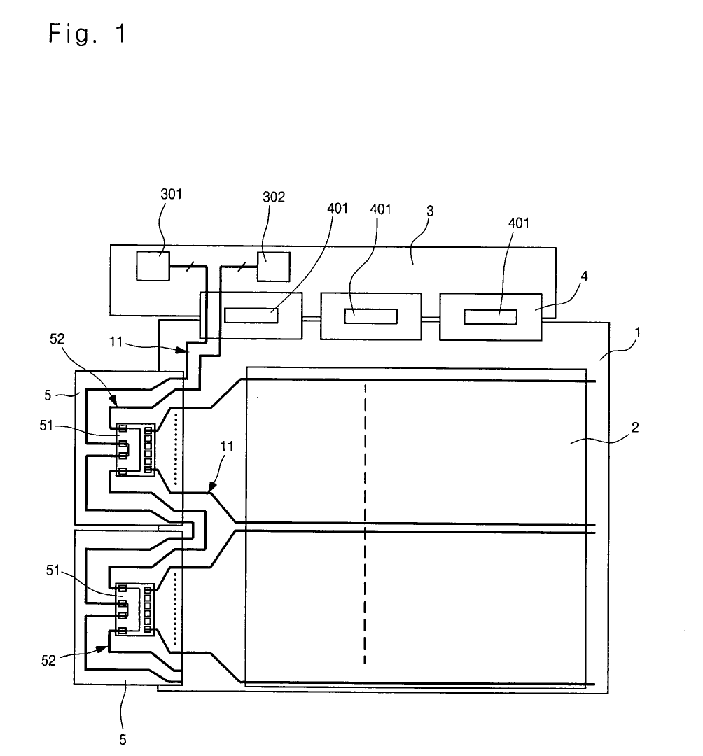

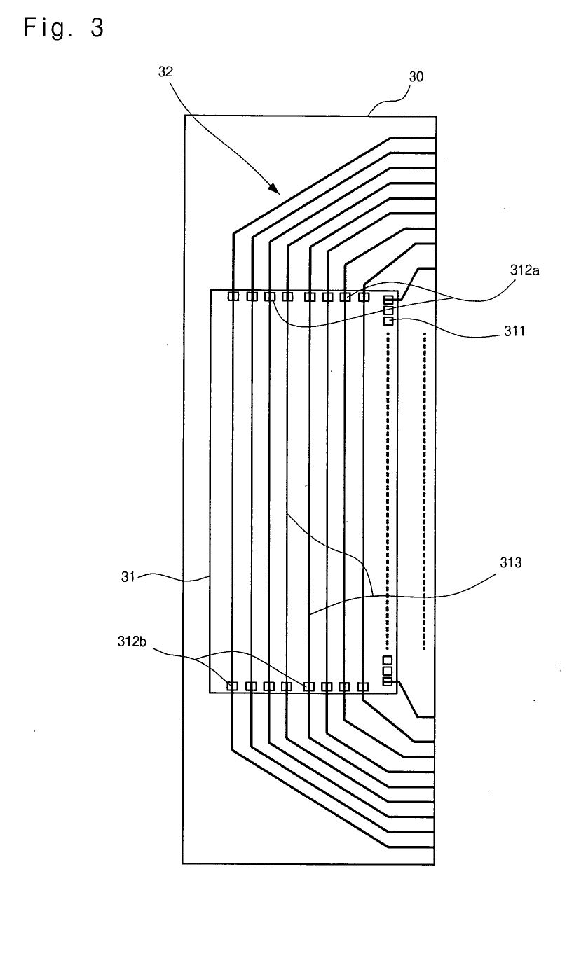

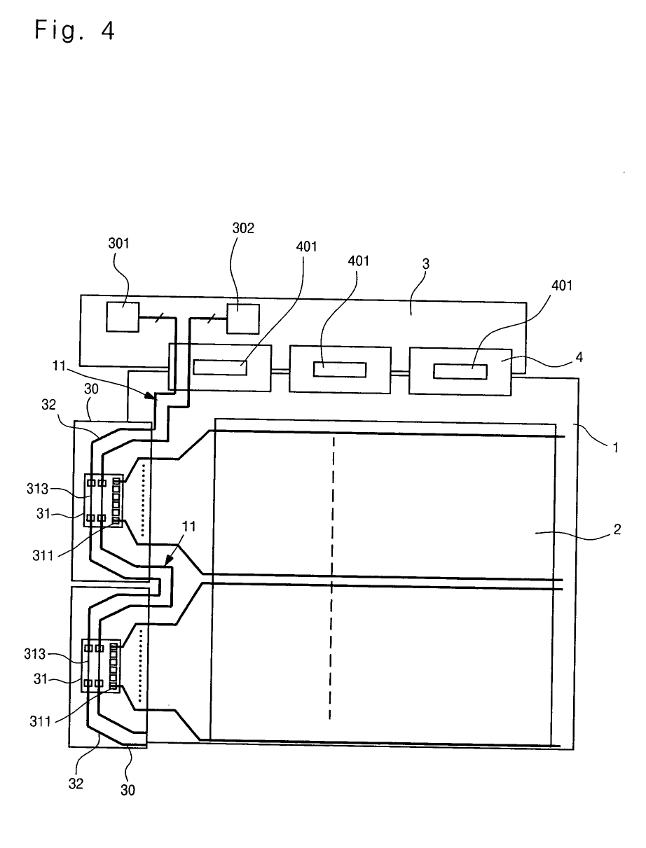

FIG. 3 is a layout for explaining a gate drive device 31 in accordance with a preferred embodiment of the invention, the device 31 of the invention is mounted on a base film 30. Besides, FIG. 4 is a layout showing how the base film 30 in FIG. 3 is applied to a lower glass 1 of the liquid crystal panel, which corresponds to FIG. 1. In FIG. 4, the same elements with those described in FIG. 1 have the same reference numerals and detailed explanation will be omitted.

In FIG. 3, the device 31 according to the present invention has a plurality of output bumps 311, formed in a row on one end of the device 31 adjacent to the liquid crystal panel in the same manner with conventional device, for outputting gate driving signals. That is, the output bumps 311 are arranged in the same direction with the liquid crystal panel or the lower glass 1.

Meanwhile, according to the present invention distinctively from the conventional device, input bumps 312a of a first group for receiving the gate driving signals from conductive patterns 32 on the base film 30 and input bumps 312b of a second group for outputting the gate driving signals input from the first input bumps 312a to the conductive patterns 32 on the base film 30 are arranged in a perpendicular direction with the liquid crystal panel or the lower glass 1, not in the opposite direction with the output bumps 311. That is, the first and second input bumps 312a and 312b are disposed perpendicularly with the array direction of the output bumps 311. And the first and second input bumps 312a and 312b are coupled with each other through metal lines 313 electrically.

In the above-described configuration, the first and second input bumps 312a and 312b are arranged on right and left ends of the device 31, respectively, on the basis of the output bumps 311. As shown in FIG. 4, the right and left ends of the output bumps 311 on the device 31 are directly connected with the conductive patterns 11 on the lower glass 1 and positioned very adjacent to the lower glass 1. Accordingly, in forming the conductive patterns 32, for electrically coupling the conductive patterns 11 of the lower glass 1 with the first and second input bumps 312a and 312b of the device 31, on the base film 30, it is possible to design the conductive patterns 32 along with straight lines between the conductive patterns 11 and the device 31, needless to go round the circumference of the device 31, differently from the conventional one. That is, it is possible to retrench the length of the base film 30 to the extent of the area for accommodating the detour patterns since it is unnecessary to prepare for detour patterns arranged on the opposite end to the output bumps 311 of the device 31.

Besides, according to the above-described configuration, it is possible to reduce the width of the device 31 to the extent of the length that the input bumps 312a and 312b need to position.

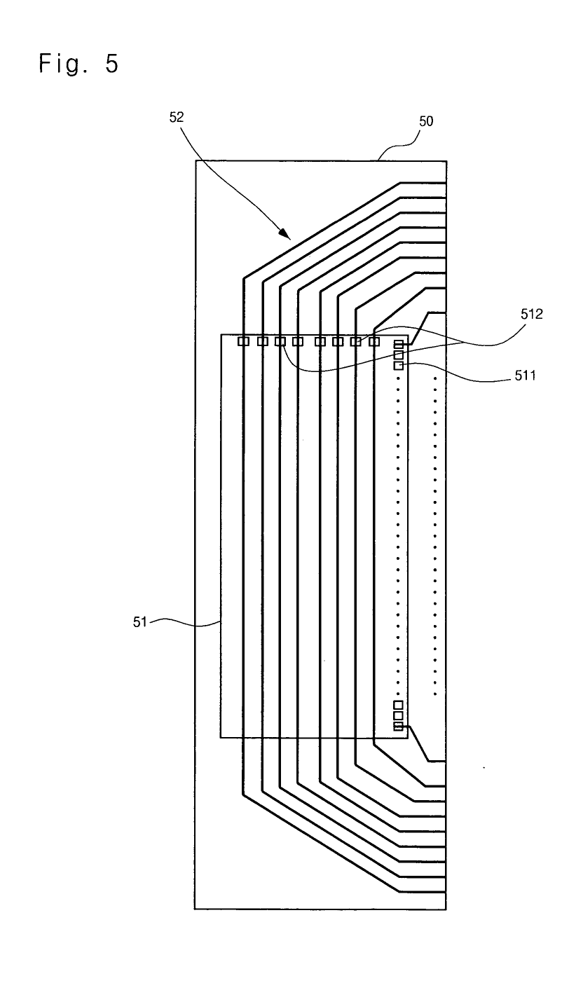

FIG. 5 is a layout illustrating a configuration of a gate drive device 51 and a base film 50 applying the device 51 in accordance with another embodiment of the invention. In the device 51 of FIG. 5 according to this embodiment, a plurality of output bumps 511 are established on one end adjacent to the liquid crystal panel in a parallel direction and a plurality of input bumps 512 for inputting the gate driving signals from conductive patterns 52 on the base film 50 are formed in a perpendicular direction with the output bumps 511 of the device 51. And the conductive patterns 52 on the base film 50 are extended from an upper end of the base film 50 to a lower end of the base film 50 under the device 51.

In the embodiment of the invention depicted in FIG. 3, the driving signals input from the lower glass 1 are coupled with the first input bumps 312a of the device 31 through the conductive patterns 32 on the base film 30 and, then, the signals coupled with the first input bumps 312a of the device 31 are sent to the second input bumps 312b through the metal lines 313 in the device 31. Subsequently, the signals are applied again to the conductive patterns 32 on the base film 30 through the second input bumps 312b. Whereas, according to the embodiment of the invention depicted in FIG. 5, the driving signals input from the lower glass 1 are transmitted repeatedly to the lower glass 1 through the conductive patterns 52 on the base film 50 and, the driving signals travel like this are supplied to the internal circuitry of the device 51 through the input bumps 512 of the device 51 coupled with the conductive patterns 52 electrically.

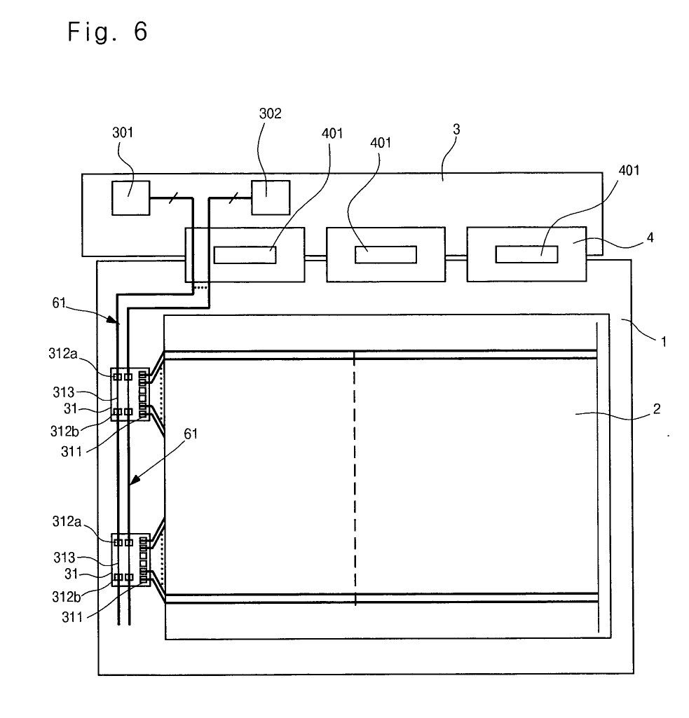

Meanwhile, FIG. 6 shows another example of the circuit array configured by using the gate drive devices 31 in FIG. 3. In FIG. 6, the same elements with those described in FIG. 4 have the same reference numerals and detailed explanation will be omitted.

According to the embodiment depicted in FIG. 6, the devices 31 are mounted direct onto the lower glass 1 of the liquid crystal panel, not using the base film 30 in FIG. 4. The devices 31 are positioned in places corresponding to gate electrodes, not depicted, formed on the lower glass 1. The gate driving signals input from the PCB 3 to the lower glass 1 through the connecting members 4 are coupled electrically with the first input bumps 312a of the device 31 through conductive patterns 61 arranged on the lower glass 1 and the signals output from the second input bumps 312b are connected electrically to the first input bumps 312a of the subsequent device 31 through the conductive patterns 61 of the lower glass 1.

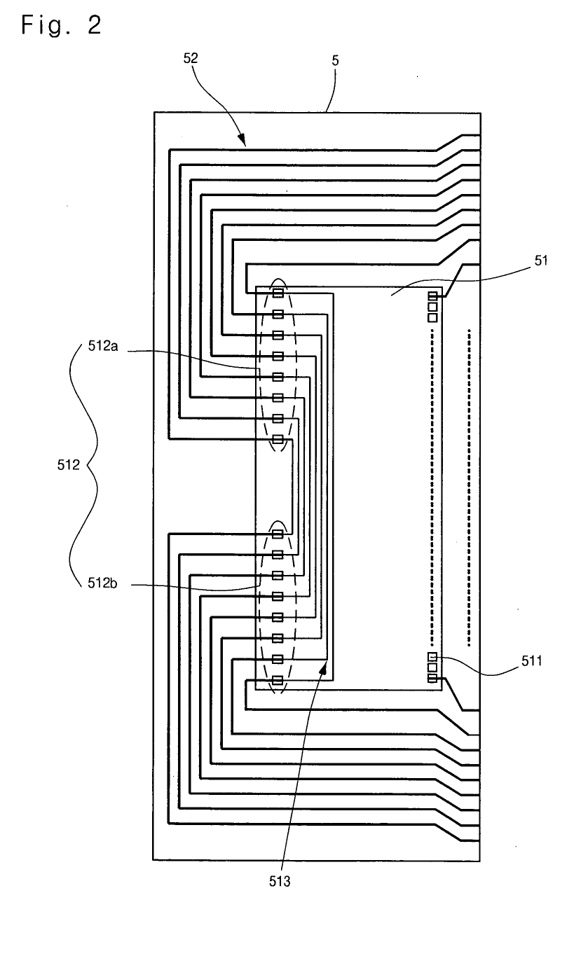

In case of the device 51 described in FIG. 2, detour patterns are needed to couple the gate driving signals with the input bumps 512 as described above. Accordingly, in case that the conventional devices 51 are mounted on the lower glass 1, there arises a drawback that further area for accommodating the detour patterns are needed on the lower glass 1.

However, according to the present invention, it is possible to eliminate the area for forming the detour patterns on the lower glass 1 since the driving signals can be coupled with the device 31 without separate detour patterns. That is, it can reduce the size of the lower glass 1 to the extent of 1 mm, for example.

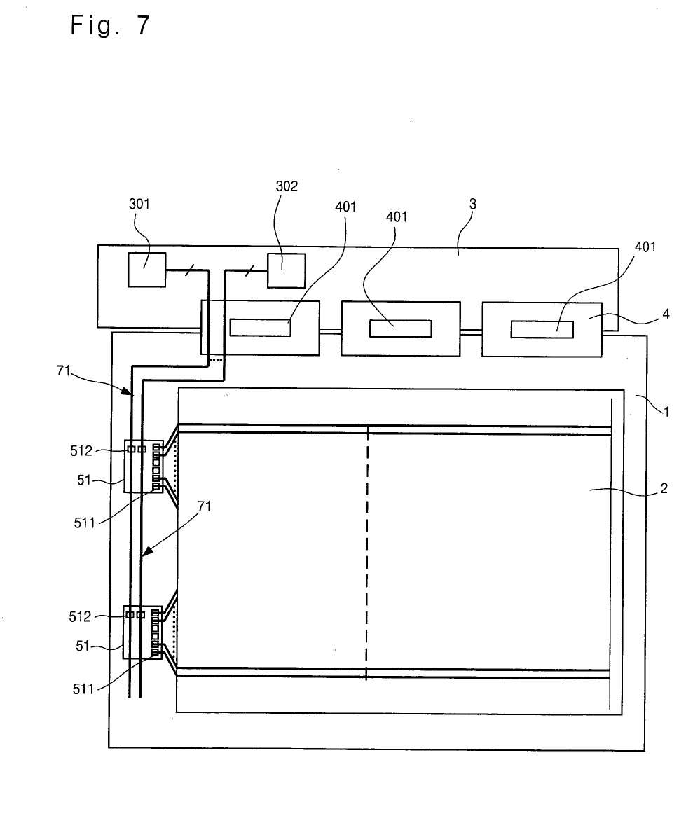

In addition, FIG. 7 illustrates another example of the circuit array configured by using the gate drive devices 51 in FIG. 5. In FIG. 7, the same elements with those described in FIG. 4 have the same reference numerals and detailed explanation will be omitted.

According to the configuration in FIG. 7, conductive patterns 71 coupled with the gate driving signals input through the connecting members 4 are extended from an upper side to a lower side of the lower glass 1 without interruption. On the conductive patterns 71, a plurality of devices 51 are mounted in places corresponding to gate electrodes, not depicted, formed on the lower glass 1. Here, input bumps 512 connected electrically to the conductive patterns 71 input the gate driving signals from the conductive patterns 71.

In the configuration of FIG. 7, it is possible to reduce the size of the lower glass 1 and, at the same time, simplifies the configuration of the conductive patterns 71 and the device 51 in the same manner with the configuration described in FIG. 6 since the conductive patterns 71 for inputting the gate driving signals from the PCB 3 are arranged linearly without interruption on the lower glass 1 and the driving signals necessary to the device 51 are only input through the input bumps 512.

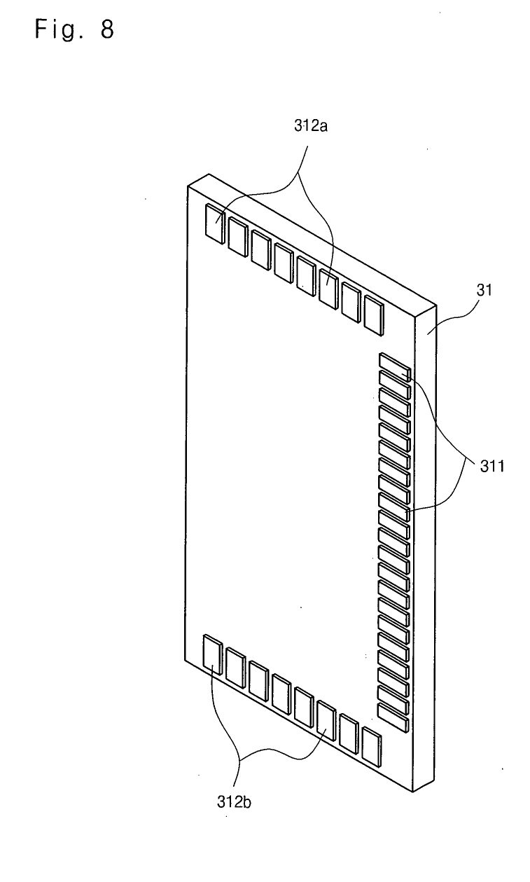

Referring to FIG. 8, a perspective view showing the exterior of the gate drive device 31 in FIG. 3, the output bumps 311 and input bumps 312a and 312b are established on the side where the base film 30 or the lower glass 1 is mounted. Here, the first and second input bumps 312a and 312b are arranged symmetrically on both ends of the device 31, whereas, the output bumps 311 are arranged on one end of the device 31. Accordingly, when pressing the device 31 having the above-described configuration on the base film 30 or the lower glass 1, a poor connection may happen due to disproportion of strength put to the device 31.

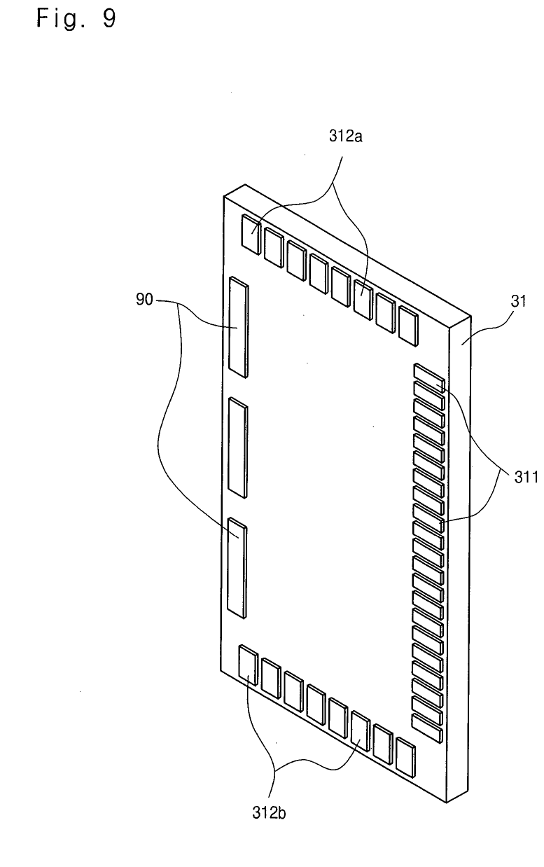

FIG. 9 is a perspective view illustrating the exterior of the gate drive device 31 for solving the above-described problem in accordance with the present invention. Predetermined dummy bumps 90 are provided on an opposite end to the output bumps 311 on the device 31. The dummy bumps 90 are designed in such a manner that the height of the dummy bumps 90 is set identical with that of the output bumps 311 and the input bumps 312a and 312b, and the length and the number are set to the extent that the strength, put to the device 31 when pressing the device 31 on the base film 30 or the lower glass 1, can be dispersed.

The configuration and the concept depicted in FIG. 9 can be applied to the device 51 in FIG. 5 as well as the device 31 in FIGS. 3 and 8 in the same manner. That is, in the configuration of the device 51 in FIG. 5, it is desirable to mount the dummy bumps on both ends opposite to the output bumps 511 and the input bumps 512, respectively.

Besides, the present invention is not limited to the embodiments described above and various modifications and variations can be made in the above-preferred embodiments of the invention.

For example, it is possible to combine the two concepts depicted in FIGS. 6 and 7 (or FIGS. 3 and 5) and mount the devices 31 including the first and second input bumps 312a and 312b on the conductive patterns 71 extended linearly so that the transmission lines, from the first input bumps 312a to the second input bumps 312b, have a dual structure in the area of the device 31.

In addition, in the above-described embodiments, description was made only for the LCD panel driving device and circuit array. However, it is possible to adapt the present invention in the same manner to the case that driving signals input from the outside are applied dependently to the plural devices.

According to the present invention as described above, it is possible to minimize the use of the base film and simplify the conductive patterns arranged on the base film or the lower glass by modifying the mounting structure of bumps on the LCD panel driving device.

Besides, according to the present invention, it is possible to reduce the width of the device by positioning the input bumps on right and left ends, respectively, on the basis of the output bumps, the input bumps established on the opposite end to the output bumps in the conventional configuration.

It will be apparent to those skilled in the art that various modifications and variations can be made in the LCD panel driving device and circuit array using the same of the present invention without departing from the spirit or scope of the invention. Thus, it is intended that the present invention cover the modifications and variations of this invention provided they come within the scope of the appended claims and their equivalents.

1. In an LCD panel driving device that receives driving signals from an outside and outputs driving signals for driving the LCD panel, the LCD panel driving device comprising:
first input bumps, established on one end of a gate drive device, for receiving driving signals from the outside;
second input bumps, formed on the other end of the gate drive device, for outputting the driving signals to the outside;
signal connecting members for coupling the first input bumps with the second input bumps electrically; and
output bumps for outputting the driving signals to the LCD panel, the first and second input bumps being arranged in a perpendicular direction with the output bumps.

2. The LCD panel driving device as recited in claim 1 further comprising dummy bumps provided on an opposite end of the output bumps.

3. In an LCD panel driving device that receives driving signals from an outside and outputs driving signals for driving the LCD panel, the LCD panel driving device comprising:
input bumps, established on one end of a gate drive device, for receiving driving signals from the outside; and
output bumps for outputting the driving signals to the LCD panel,
the input bumps being arranged in a perpendicular direction with the output bumps.

4. The LCD panel driving device as recited in claim 3 further comprising dummy bumps provided on an opposite end of the output bumps.

5. In a circuit array for driving an LCD panel that includes a printed circuit board PCB having a device for generating driving signals for driving the LCD panel and connecting members for connecting the PCB with a lower glass of the LCD panel electrically and physically to supply the driving signals with the LCD panel, the circuit array comprising:
a plurality of base films, connected with the lower glass of the LCD panel, having the LCD panel driving device and first conductive patterns; and
second conductive patterns, formed on the lower glass of the LCD panel, for coupling with the first conductive patterns electrically,
the LCD panel driving device including output bumps for outputting the driving signals to the LCD panel and at least a row of input bumps arranged in a perpendicular direction with the output bumps.

6. In a circuit array for driving an LCD panel that includes a printed circuit board PCB having a device for generating driving signals for driving the LCD panel and connecting members connecting the PCB with a lower glass of the LCD panel electrically and physically to supply the driving signals with the LCD panel, the circuit array comprising:
conductive patterns that are formed on the lower glass and coupled with the driving signals input through the connecting members;
output bumps, mounted on the conductive patterns, for outputting the driving signals to the LCD panel; and
at least a row of input bumps being arranged in a perpendicular direction with the output bumps.
